(19) United States
(12) Patent Application Publication
(10) Pub. No.: US 2005/0006632 A1
(43) Pub. Date: Jan. 13, 2005

(54) Alignment pulley

(76) Inventor: Mark Blackwood, Pinellas Park, FL (US)

Correspondence Address: Mark C. Blackwood, 6081 65 Avenue North, Pinellas Park, FL, 33781, US

(21) Appl. No.: 10/650,203

(22) Filed: Aug. 29, 2003

Related U.S. Application Data
(60) Provisional application No. 60/476,572, filed on Jun. 9, 2003.

(51) Int. Cl. B66D 1/00

(52) U.S. Cl. 254/323

(57) ABSTRACT

A deck mountable pulley designed to align automobiles with the rear of a flat bed truck, from any angle, up to ninety degrees from the longitude axis of the pulley. The present invention, working in concert with a winch and suitable length of cable, will allow for the operator of a flatbed wrecker to pull an automobile out of hard to reach places and align one end of the automobile with the back end of the flatbed truck. A pulley cable moves around a rotatable drum, affixed to the rear of the flat bed tow truck. The drum is mounted to a base plate having a center spindle. The spindle is set into a similar circumference sized receiving hole on the rear deck of the flat bed truck. A retaining pin is inserted crossways through the bottom portion of the spindle, which when correctly installed, is located directly underneath the bed of the wrecker, to provide stability for the pulley. Two L-shaped brackets, mounted on top of the base plate, rise vertically on opposing sides of the base plate and are outside the perimeter of the rotatable drum. The purpose of the L-shaped brackets, is to keep the cable in place, should the cable become slack, while the cable rotates around the drum.

### CROSS-REFERENCE TO RELATED APPLICATIONS:

Provisional Patent Application No. 60/476,572 Filed Jun. 9, 2003

### FEDERALLY SPONSORED RESEARCH: Not Applicable

### SEQUENCE LISTING OR PROGRAM: Not Applicable

### FIELD OF INVENTION

This invention relates to a deck mountable pulley having a rotatable drum for the alignment of a cable from a winch to a target that is in excess of zero degrees and up to ninety degrees from the longitudinal axis of the pulley.

### BACKGROUND OF INVENTION

Pulleys are typically used to assist with the moving of an object from one point to another. In many cases, one end of a cable or rope is attached to a targeted object and the other end is attached to a winch that either winds or unwinds the cable, and in doing so moves the targeted object either forward towards the winch, or backwards away from the winch. A pulley that is incorporated between the winch and the target object, allows for the object to be moved from a multitude of different angles.

I have identified the need for a pulley as it relates to rollback wreckers, which are also commonly referred to as flatbed tow trucks. Typically, in order to successfully get a vehicle on to the back of a flatbed wrecker, the tow truck operator has to align the back of the truck's lowered deck, end to end, with the front or rear end of the target vehicle and then use a winch and cable system to pull the vehicle up onto the deck of said wrecker. A problem arises when the tow truck operator is not able to properly align the back of the truck with the front or rear of the target vehicle. Examples included natural obstructions, such as trees, rocks, bodies of water, and steep grades, as well as man made obstructions, such as buildings, sidewalks, guard rails, other vehicles, and most notably, narrow roadways. The examples cited cause the operator of the flatbed tow truck to have to resort to finding an ulterior method to align the back of the truck with the front or back end of the targeted vehicle. An ulterior method involves the placing of rotatable pulley and spindle at or near the rear of the wrecker's bed. Doing this allows the tow truck operator to string a length of cable from the winch down the length of the truck bed and then around the pulley so that the winch cable can then be directed to it's intended target such as a disabled vehicle that is off center from the back of said truck.

Garwood/Feller's design, as illustrated on page 54 of Tow Times industry magazine, June 2003 edition, discloses an alignment pulley system that achieves the goal of allowing flexibility in the direction that the winch cable can be taken, but to install the prior art, the wrecker must first be modified by drilling five different holes through the top of it's metal bed and then retrofitted with the prior art which is then bolted into place. The retrofitting takes time and also permanently alters the bed of the wrecker truck.

The Garwood/Feller (prior art) design does not include the safety feature of vertical brackets that assist in keeping the length of cable from flying, at high speeds, to the right or left sides of the prior art, should an accident occur and the cable snaps under increased pressure.

### BACKGROUND OF INVENTION—OBJECTS AND ADVANTAGES

The present invention provides a relatively simple, convenient and dependable means to bring the targeted vehicle into proper alignment with the back of the flatbed wrecker. The center post of the spindle, that is located on the underside of the present invention, is simply set into the already present, vertical hole, on the wrecker's deck, that is similar in circumference to that of the spindle. The hole, commonly referred to as a “cut out” is a standard feature on most, if not all, modem flat bed wreckers. The main retaining pin is then inserted through the horizontal hole of the spindle, which when in position, is located below the deck of the wrecker. Two clips are then attached at ether end of the main retaining pin to keep the main retaining pin from slipping through the hole of the spindle, Once the present invention is correctly attached to the bed of the wrecker, the winch cable can then be wrapped around either side of the rotatable drum and then run, at differing angles, anywhere from zero to ninety degrees, to it's intended target, such as the front or rear of a disabled motor vehicle. There are two vertical safety brackets, mounted to a base plate, that are located near to and on opposite sides of the rotatable drum that help with keeping the cable in place on the drum as it rotates. This offers a safety feature that the prior art, Garwood/Feller (Tow Times magazine June 2003), does not offer in it's design. Additionally, the deck of the truck does not have to be drilled, cut or altered in anyway to accommodate the present invention.

There are several advantages to the present invention. Examples include:

1 The present invention is portable.
2 The present invention is able to be installed into pre-existing “cut out” holes at the rear of the wrecker. Therefore, no modifications have to be made to the bed of the truck itself.
3 The present invention can be quickly installed or uninstalled and is small and light enough in it's design to be easily stored on or inside of the tow truck.
4 The present invention provides a relatively low cost tool for the wrecker operator to use when trying to pull stranded or disabled vehicle out of tight spots where the back of the wrecker cannot be properly aligned with the front or back of the targeted vehicle.
5 The present invention includes two vertical safety brackets that increase the safety of the present invention's overall operation.
   These advantages will be more clearly appreciated upon reference to the following detailed description having reference to the accompanying drawings.

### SUMMARY

In accordance with the present invention the alignment pulley is comprised of the rotatable drum, rotatable hub, two vertically mounted cable guide brackets, base plate, spindle with center post, retaining pin, and three retaining clips.

### DRAWINGS—REFERENCE NUMERALS

| | | | |
|---|---|---|---|
| 20 | cap | 21 | drum |
| 22 | lug nut | 23 | lug bolt |
| 24 | hub | 25 | spindle |
| 26 | L shaped bracket | 27 | base plate |
| 28 | retaining clip | 29 | retaining pin |
| 30 | v-shaped pin | 31 | nut |
| 32 | washer | 33 | roller bearing |
| 40 | deck | | |

### DRAWINGS—FIGURES

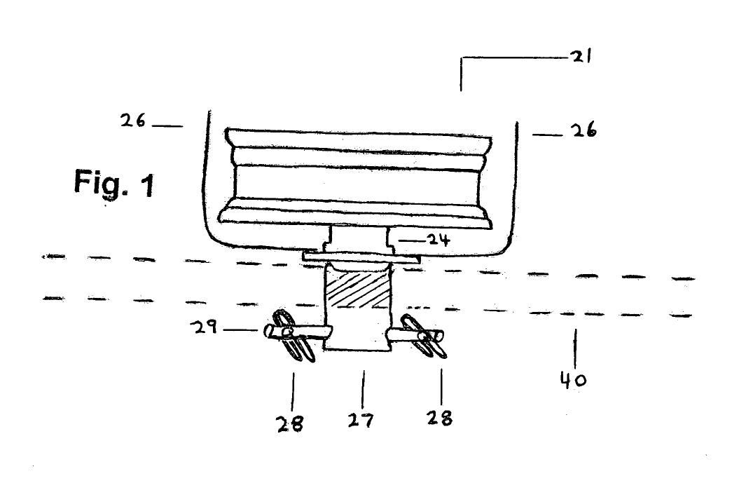

FIG. 1 depicts the present invention as it is properly installed and attached to the deck of a flatbed wrecker. The broken, horizontal lines represent the bed of the wrecker. The rotatable drum sits above the wrecker bed and the center post, with locking pin, protrudes from under the wrecker deck.

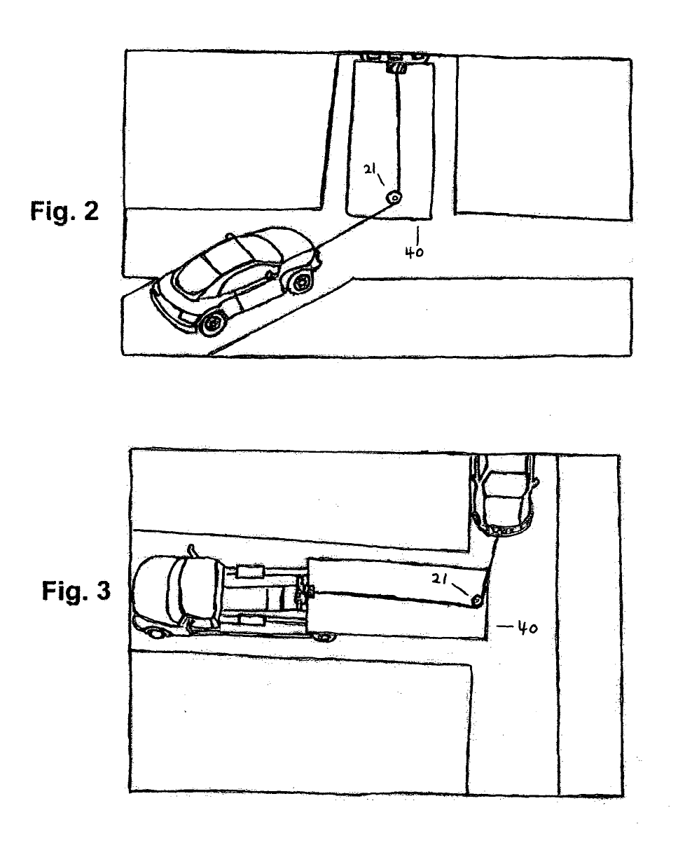

FIG. 2 depicts a passenger vehicle being pulled towards the back of a flatbed wrecker from a forty five degree angle. A cable is shown leading from the truck's winch, through the present invention and onward to the front of the passenger vehicle.

FIG. 3 depicts a vehicle being pulled to the back of a flatbed wrecker from a ninety degree angle. A cable is shown leading from the truck's winch, through the present invention and onward to the front of the passenger vehicle.

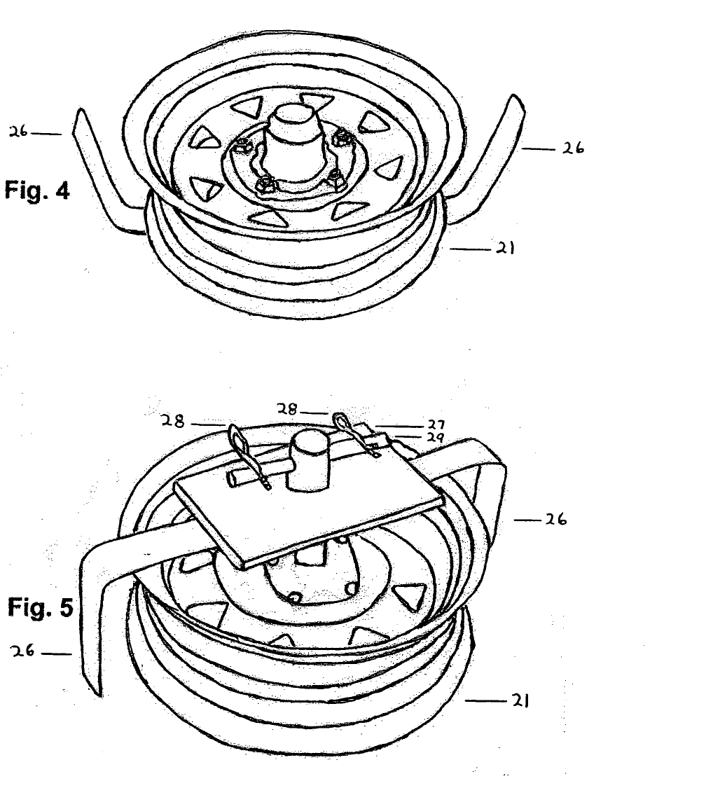

FIG. 4 depicts the top view of the present invention. The drawing shows the spindle cap, 4 lug bolts, 4 lug nuts, and the two L shaped brackets.

FIG. 5 depicts the underside of the present invention. For this view, the present invention has been drawn with it's topside down. The drawing shows the center post of the spindle protruding vertically through the base plate. The retaining pin is shown protruding horizontally through the center post. Two retaining clips are shown protruding horizontally through the retaining pin. There are two L shaped brackets that are shown protruding from the base plate in a horizontal direction and then curving into a vertical direction on opposing sides of the rotatable drum.

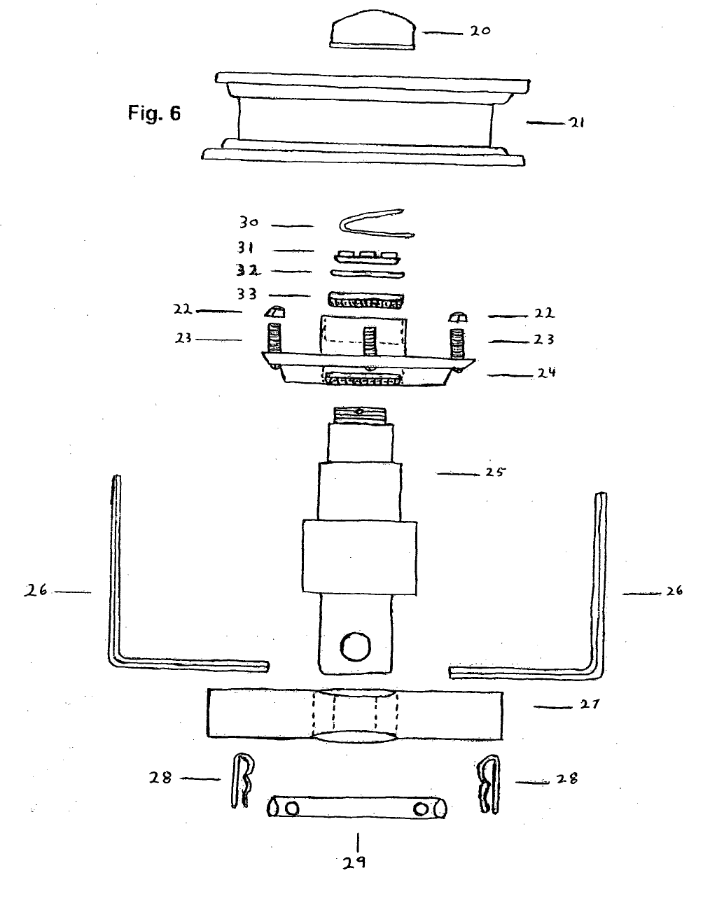

FIG. 6 depicts an exploded view of the present invention with each of it's parts numbered for reference.

### DESCRIPTION OF THE PREFERRED EMBODIMENT

Refer to FIG. 1 of the drawings which illustrate the present invention as it is mounted to the deck 40 of a flatbed wrecker. For the purpose of this illustration the deck 40 of the wrecker is illustrated with broken lines running in a horizontal direction. The center post of the spindle 25 is shown protruding through the bottom of the wrecker deck 40. The hole that runs in a horizontal direction through the bottom of the spindle 25 allows for receiving of a retaining pin 29. The retaining pin 29 is held in place by two retaining clips 28 that are positioned at opposite ends of the retaining pin 29. The retaining clips 28 are inserted through two holes on either end of the retaining pin 29 in order to keep the retaining pin 29 from slipping through and out of the horizontal hole in the bottom center post of the spindle 25.

Refer to FIG. 6 of the drawings which illustrate an exploded view of the present invention. The present invention contains the hub 20 which is vertically hollow in it's center and is fitted to the spindle 25 by placing the spindle 25 upward through the underside of the hub 24. The underside of the hub 24 is wider in circumference than it's top side. The hub 24 contains 4 vertical lug bolts 23 that are positioned in equal distances around the outside of the hub 24. The head of the lug bolts 23 are positioned on the underside of the hub 24 and rise upward through holes in the hub 24. Inside the hub 24 there are two sets of roller bearings 33. The first roller bearing 33 is placed into the void on the underside of the hub 24. The second roller bearing 33 is placed into the void on the top side of the hub 24. The narrow end of the spindle 25 is then inserted into the void on the underside of the hub 24 until the lower set of roller bearings 33 become seated on the lip of the spindle 25 which is wider in circumference than the top of the spindle 25. The washer 32 is then positioned around the top of the spindle 25 and is seated on top of the upper set of roller bearings 33. The nut 31 is then fastened to the top of the spindle 25 which is threaded. There is a small hole that runs horizontally through the threaded top of the spindle 25 that accepts the V shaped pin 30. The aluminum end cap 20 is then pushed down snugly into place on top of the hub 24 and protects the roller bearings 33 from foreign matter such as dirt and water. The bearings 33 allow the hub 24 to spin freely around the spindle 25. The bottom of the spindle 25 is inserted through a hole in the top and in the center of a base plate 27. The spindle 25 stops when it's lip which is wider in circumference in it's middle than it is at it's bottom end becomes seated on the top of the base plate 27. The base plate 27 is attached to the spindle 25 by welding the two pieces together both on the top side and underside of the base plate 27. Two L shaped brackets 26 are affixed to the top of the base plate 27 by welds and are positioned opposite one another. The L shaped brackets 26 point upward and act as guides to keep the winch cable in place should the cable become slack. Once the spindle 25 and hub assembly 24 are in place along with the L shaped brackets 26 the drum 21 can then be fastened to the hub 24 by inserting the lug bolts 23 through the holes in the center of the drum 21. The drum 21 in this present invention is a 12″ diameter wheel that is commonly used as an automobile's wheel rim. The drum 21 and hub 24 are compatible in their make up and because of this the hub 21 and it's lug bolts 23 can easily receive the drum 21. The four lug nuts 22 are fastened to the threads of the lug bolts 23 and once on are able to secure the drum 21 to the hub 24.

Those skilled in the art will recognize that modifications and variations may be made without departing from the true spirit and scope of the present invention. The present invention is therefore not to be limited to the embodiments described and illustrated but is to he determined from the appended claims.

1. Canceled

2. A pulley system which comprises:
a base structure,
a vehicle having a deck,
a spindle having associated bearings,
the spindle being coupled to the deck,
a rotatable drum,
a means for mounting and removing said base structure and rotatable drum from the deck of the vehicle,
two vertical safety brackets
